(19) United States
(12) Patent Application Publication
(10) Pub. No.: US 2025/0185043 A1
(43) Pub. Date: Jun. 5, 2025

(54) METHODS, DEVICES, AND MEDIUM FOR COMMUNICATION

(71) Applicant: NEC CORPORATION, Tokyo (JP)

(72) Inventor: Gang WANG, Beijing (CN)

(73) Assignee: NEC CORPORATION, Tokyo (JP)

(21) Appl. No.: 18/833,635

(22) PCT Filed: Jan. 28, 2022
(86) PCT No.: PCT/CN2022/074701

§ 371 Date: Jul. 26, 2024

(51) Int. Cl. H04W 72/30; H04B 7/06; H04W 24/10; H04W 72/54; H04W 76/18

(52) U.S. Cl. CPC H04W 72/30; H04B 7/06964; H04W 24/10; H04W 72/54; H04W 76/18

(57) ABSTRACT

Example embodiments of the present disclosure relate to an effective mechanism for identifying the terminal. In this solution, the first terminal device determines whether a broadcast condition for an identification message is satisfied based on at least one of a connection status, a time interval, a location of the first terminal device and an indication from an upper layer. Further, first terminal device broadcasts the identification message of the first terminal device if the broadcast condition for an identification message is satisfied. In this way, an event triggered reporting between terminal devices is achieved, which may achieve an assist resource management and collision avoidance or tracking.

### FIELD

Embodiments of the present disclosure generally relate to the field of telecommunication, and in particular, to methods, devices, and medium for identifying terminal devices, especially unmanned aerial vehicles (UAVs).

### BACKGROUND

Unmanned vehicles, such as unmanned aerial vehicles (UAVs) have been developed for use in a variety of fields, including consumer and industry applications. For instance, UAVs may be flown for recreation, photography/videography, surveillance, delivery, or other applications.

UAVs have expanded a dimension of the lives of individuals. However, as the use of UAVs has become more prevalent, safety issues and challenges arise. For example, if an UAV is not identified by other UAVs or the network devices, a collision may occur among the UAVs and the network devices may fail to perform an efficient tracking or management for the unidentified UAVs. Thus, it is desirable to propose a solution for identifying the UAVs.

### SUMMARY

In general, example embodiments of the present disclosure provide solutions for identifying the UAVs. Embodiments that do not fall under the scope of the claims, if any, are to be interpreted as examples useful for understanding various embodiments of the disclosure.

In a first aspect, there is provided a method of communication. The method comprises: determining, at a first terminal device, a broadcast condition for an identification message is satisfied in response to at least one of the following: a connection status between the first terminal device and an access network device failing to satisfy a connection requirement; a time interval since a last transmission of an identification message of the first terminal device exceeding a period threshold, the first terminal device entering into a specific spatial area, or receiving an indication from an upper layer of the first terminal device, the indication instructing the first terminal device to broadcast the identification message of the first terminal device. The method further comprises broadcasting the identification message of the first terminal device.

In a second aspect, there is provided a method of communication. The method comprises: receiving, at a second terminal device, a second configuration from a network device, the second configuration being used for triggering the second terminal device to transmit a report comprising at least part of at least one identification message, the at least one identification message being received from at least one first terminal device. The method further comprises transmitting, to the network device, the report comprising at least part of the at least one identification message if a forward condition is satisfied.

In a third aspect, there is provided a method of communication. The method comprises: transmitting, at a network device, a second configuration to be used by a second terminal device, the second configuration used for triggering the second terminal device to transmit a report comprising at least one identification message received from at least one first terminal device. The method further comprises receiving a report comprising at least one identification message, the report being transmitted by the second terminal device in response to a forward condition being satisfied.

In a fourth aspect, there is provided a method of communication. The method comprises: receiving, at a first terminal device, an identification request indicating spatial area of interests, the identification request being transmitted via a broadcast manner. The method further comprises transmitting an identification response to the second terminal device.

In a fifth aspect, there is provided a method of communication. The method comprises: broadcasting, at a second terminal device, an identification request indicating spatial area of interests. The method further comprises receiving an identification response from a first terminal device.

In a sixth aspect, there is provided a method of communication. The method comprises: receiving, at a first terminal device and from a second terminal device, a measurement configuration comprising information about at least one condition that triggers the first terminal device to transmit a location report. The method further comprises transmitting, to the second terminal device, a location report if one or more of the at least one condition are satisfied.

In a seventh aspect, there is provided a method of communication. The method comprises: transmitting, at a second terminal device and to a first terminal device, a measurement configuration comprising information about at least one condition that triggers the first terminal device to transmit a location report. The method further comprises receiving a location report from the first terminal device, the location report being transmitted by the first terminal device in response to one or more of the at least one condition being satisfied.

In an eighth aspect, there is provided a first terminal device. The first terminal device includes a processing unit; and a memory coupled to the processing unit and storing instructions thereon, the instructions, when executed by the processing unit, causing the device to perform the method according to the first aspect.

In a ninth aspect, there is provided a second terminal device. The second terminal device includes a processing unit; and a memory coupled to the processing unit and storing instructions thereon, the instructions, when executed by the processing unit, causing the device to perform the method according to the second aspect.

In a tenth aspect, there is provided a network device. The network device includes a processing unit; and a memory coupled to the processing unit and storing instructions thereon, the instructions, when executed by the processing unit, causing the device to perform the method according to the third aspect.

In an eleventh aspect, there is provided a first terminal device. The first terminal device includes a processing unit; and a memory coupled to the processing unit and storing instructions thereon, the instructions, when executed by the processing unit, causing the device to perform the method according to the fourth aspect.

In a twelfth aspect, there is provided a second terminal device. The second terminal device includes a processing unit; and a memory coupled to the processing unit and storing instructions thereon, the instructions, when executed by the processing unit, causing the device to perform the method according to the fifth aspect.

In a thirteenth aspect, there is provided a first terminal device. The first terminal device includes a processing unit; and a memory coupled to the processing unit and storing instructions thereon, the instructions, when executed by the processing unit, causing the device to perform the method according to the sixth aspect.

In a fourteenth aspect, there is provided a second terminal device. The second terminal device includes a processing unit; and a memory coupled to the processing unit and storing instructions thereon, the instructions, when executed by the processing unit, causing the device to perform the method according to the seventh aspect.

In a fifteenth aspect, there is provided a computer readable medium having instructions stored thereon, the instructions, when executed on at least one processor, causing the at least one processor to carry out the method according to any of the above first to seventh aspects.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates a signaling chart of a process for identifying a UAV in the related solution;

FIG. 2 illustrates an example communication environment in which example embodiments of the present disclosure can be implemented;

FIG. 3 illustrates a signaling chart of a process for communication according to some embodiments of the present disclosure;

FIG. 4 illustrates a signaling chart of a process for communication according to some embodiments of the present disclosure;

FIG. 5 illustrates a signaling chart of a process for communication according to some embodiments of the present disclosure;

FIGS. 6A to 6D illustrate signaling charts of a process for communication according to some embodiments of the present disclosure;

FIGS. 7A and 7B illustrate signaling charts of processes for communication according to some embodiments of the present disclosure;

FIG. 8 illustrates a signaling chart of a process for communication according to some embodiments of the present disclosure;

FIG. 9 illustrates a signaling chart of a process for communication according to some embodiments of the present disclosure;

FIG. 10 illustrates an example method performed by a first terminal device according to some embodiments of the present disclosure;

FIG. 11 illustrates an example method performed by a second terminal device according to some embodiments of the present disclosure;

FIG. 12 illustrates an example method performed by a network device according to some embodiments of the present disclosure;

FIG. 13 illustrates an example method performed by a first terminal device according to some embodiments of the present disclosure;

FIG. 14 illustrates an example method performed by a second terminal device according to some embodiments of the present disclosure;

FIG. 15 illustrates an example method performed by a first terminal device according to some embodiments of the present disclosure;

FIG. 16 illustrates an example method performed by a second terminal device according to some embodiments of the present disclosure; and

FIG. 17 illustrates a simplified block diagram of an apparatus that is suitable for implementing example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “terminal device” refers to any device having wireless or wired communication capabilities. Examples of the terminal device include, but not limited to, UE, personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also be incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “access network device” used herein refers to a device which is capable of providing or hosting a cell or coverage where terminal devices can communicate. Examples of a network device include, but not limited to, a satellite, a unmanned aerial systems (UAS) platform, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), an aerial node, a UxNB, a master node and the like.

The term “core network device”/“CN device” used herein refers to any device or entity that provides access and mobility management function, session management function (SMF), user plane function (UPF), or may be an application server, a third party network/application and so on. By way of example rather than limitation, the core network device may be a mobility management entity (MME), an AMF, a SMF, a UPF, network exposure function (NEF), uncrewed aerial system (UAS) traffic management UTM, UAS service supplier (USS), third party authorized entity (TPAE), UAV flight enablement subsystem (UFES), unified data management (UDM), and so on.

The term “network device” used herein refers to any device or entity that may provide services to a terminal device. By way of example rather than limitation, the network device may be either an access network device or a core network device.

The terminal device or the network device may have artificial intelligence (AI) or machine learning capability. It generally includes a model which has been trained from numerous collected data for a specific function, and can be used to predict some information.

The terminal or the network device may work on several frequency ranges, e.g. FR1 (410 MHz-7125 MHZ), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As discussed previously, if a terminal device (especially a UAV) is not properly identified by other UAVs or the network devices, a collision may occur among the UAVs and the network devices may fail to perform an efficient tracking or managements for the unidentified UAVs. Thus, it is expected that the UAVs may be well identified in a cellular communication network (such as, a third-generation partner program, 3GPP, network).

So far, some discussions for identifying the UAVs have been made in the related solutions.

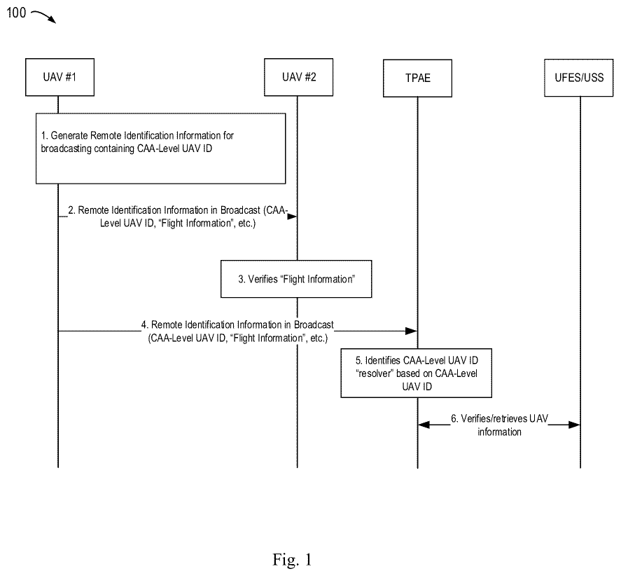

Reference is now made to FIG. 1, which illustrates a signaling chart 100 of a process for identifying a UAV in the related solution. As illustrated in FIG. 1, UAV #1 generates remote identification information for broadcasting, where the remote identification information may comprise a containing clear channel assessment (CAA)-level UAV identification (ID). Then, UAV #1 may broadcast the remote identification information (including a CAA-Level UAV ID, “Flight Information” and so on), and both UAV #2 and the TPAE may receive the remote identification information.

Next, UAV #2 may verify the “Flight Information” to avoid collision while the TPAE may identify CAA-level UAV ID based on CAA-Level UAV ID. Further, the TPAE also may verifies/retrieves UAV information with the UFES/USS.

It can be seen that this related solution merely discloses that a UAV may be identified by other devices (such as, a further UAV or the TPAE). Further, the federal aviation administration (FAA) proposes a requirement for identifying the UAS without providing a clear feasible solution.

In addition to the above, some agreements have been reached by 3GPP. Specifically, it is expected that a UE functioning as an aerial UE (such as, a UAV) in the LTE network is identified via subscription information. This subscription information is signaled by the MME to the eNB in the Initial Context Setup procedure and from the source eNB to the target eNB in the handover procedure. Further, the eNB may use this information in combination with radio capability indication to identify an aerial UE and to perform the necessary control and to apply the relevant functions.

It can be seen that, the 3GPP merely stipulates a generalized procedure about identifying the UAVs. However, the actual wireless communication condition is more complicated, such, an aerial UE may be out of coverage or may be just powered on. Such generalized procedure cannot suitable for the complicated wireless communication condition, which results that some UAVs cannot be well identified.

In order to solve the above and other potential problems, embodiments of the present disclosure provide an effective mechanism for identifying terminal devices, especially UAVs.

For ease of discussion, some terms and expressions used in the following description are listed as below:
The term “a first terminal device”: refers to a terminal device that may provide identification/presence information (such as, identification information, location report, measurement report/information, UE assistance information, UE information response and any suitable information that may be used to identify the first terminal device) to other devices via a unicast, multi-cast or broadcast manner/channel.
The term “a second terminal device”: refers to a terminal device that May receive the identification/presence information of the first terminal device. In some embodiments, the second terminal device may utilize the received identification/presence information by itself. Alternatively, the second terminal device may function as a relay device and transmit the received identification/presence information (such as, via a report) to other devices (including an access network device or a core network device).
The term “UAS” refers to a system comprising a UAV and a UAV controller, or refers to a UAV. Further, in some embodiments, the UAV controller may be implemented as a virtual unit or module at a network device.
The term “first valid time window” refers to time duration used by a second terminal device for identifying a first terminal device (such as, identifying a UAS or identifying a UAV). For example, the second terminal device may collect the identification/presence information, and/or transmit the report comprising the collected the identification/presence information during the first valid time window.
The term “second valid time window” refers to time duration to be used by a first terminal device for transmitting the identification/presence information (such as, an identification response). Specifically, a first terminal device may generate and/or transmit identification/presence information within the second valid time window.

In this present disclosure, some terms may refer to same or similar physical meaning and may be used interchangeably. Some exemplary examples are listed as below.
Terms “broadcast manner”, “broadcast”, “broadcast channel” and their similar expressions may be used interchangeably.
The terms “UAS”, “UAV”, “aerial UE”, “aerial UE terminal device” and their similar expressions may be used interchangeably.
The terms “remote identification message”, “identification message”, “identification information” and their similar expressions may be used interchangeably.
The terms “received identification messages”, “identified terminal devices”, “identified UAVs”, “identified UASs” and their similar expressions may be used interchangeably.
The terms “duration”, “window”, “period”, “interval” and their similar expressions may be used interchangeably.
The terms “sidelink”, “sidelink transmission”, “PC 5 interface” and their similar expressions may be used interchangeably.
The terms “message”, “information”, “configuration”, “signalling”, “report” and their similar expressions may be used interchangeably.
The terms “upper layer” and “application layer”, “non-access stratum” and their similar expressions may be used interchangeably.
The terms “condition”, “criteria”, “rule”, “policy” and their similar expressions may be used interchangeably.

In this disclosure, different devices may communicate with each other via different communication manners. Some examples of communication manners among different device are listed as below.
Communication manners among terminal devices: unicast manner and broadcast manner; such as, via a sidelink transmission, or PC 5 interface;
Communication manners among a terminal device and access network device: unicast manner and broadcast manner (from the access network device to the terminal device); such as, via a wireless link/channel;
Communication manners among a terminal device and core network device: unicast manner; such as, via a NAS transmission, which is transparent with respect to the access network device;
Communication manners among an access network device and core network device: unicast manner.

It is to be understood that the above communication manners are only for the purpose of illustration without suggesting any limitations. In some other example embodiments, any suitable other communication manners may be applied for communication according to the specific scenario. The present disclosure is not limited in this regard.

In the following, a UAV will be used as an example of a terminal device for describing some specific example embodiments of the present disclosure. It is noted that example embodiments described with regard to the UAV are equally applicable to other terminal device that may function as an aerial UE/terminal.

Principle and example embodiments of the present disclosure will be described in detail below with reference to the accompanying drawings.

### Example Environment

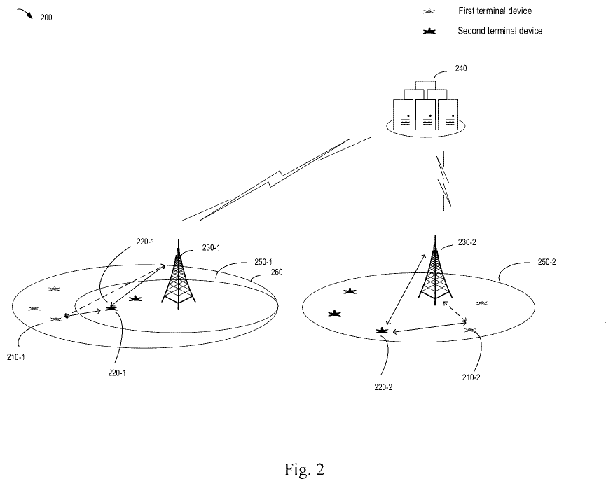

FIG. 2 shows an example communication environment 200 in which example embodiments of the present disclosure can be implemented. The network environment 200 includes terminal devices 210-1, 210-2, 220-1 and 220-2. In the following text, the terminal devices 210-1 and 210-2 are collectively referred to as the first terminal devices 210 or individually referred to as the first terminal devices 210, while the terminal devices 220-1 and 220-2 are collectively referred to as the second terminal devices 220 or individually referred to as the second terminal devices 220.

The terminal devices 210-1, 210-2, 220-1 and 220-2 may communicate with each other via a unicast or broadcast manner. As illustrated in FIG. 2, the first terminal device 210-1 and the second terminal device 220-1 may communicates with each other via a unicast or broadcast manner, while the first terminal device 210-2 and the second terminal device 220-2 may communicates with each other via a unicast or broadcast manner.

Further, the communication environment 200 also comprises access network devices 230-1 and 230-2, which provide services to the terminal device 210-1, 210-2, 220-1 and 220-2. In the following text, the access network devices 230-1 and 230-2 are collectively referred to as the access network devices 230 or individually referred to as the network device 230.

Additionally, any of the access network devices 230-1 and 230-2 may provide one or more serving areas (also referred to as “cell” sometimes) to the terminal device(s) within its coverage. In the specific example of FIG. 2, the access network device 230-1 provides serving area 250-1 and the access network device 230-2 provides serving area 250-2. Serving areas 250-1 and 250-2 hereinafter are collectively referred to as the serving areas 250 or individually referred to as a serving area 250.

In case that the terminal device 210/220 is within a serving area 250 of the respective access network device 230, the terminal device 210 may communicate with the respective access network device 230 via such as a service link or radio link. Communication in a direction from a terminal device 210/220 towards the access network device 230 is referred to as uplink communication, while communication in a reverse direction from the access network device 230 towards the terminal device 210/220 is referred to as downlink communication.

In addition, the communication environment 200 also comprises a core network device 240, which may communicate with the access network devices 230-1 and 230-2, while may communicate with the terminal devices 210-1, 210-2, 220-1 and 220-2 via a NAS transmission.

In addition, in the specific example of FIG. 2, both the terminal devices 210 and the access network devices 230 may move over time. When moving, the terminal devices 210 may be located in different serving areas 250 and also may be out of the coverage of the network sometimes. In one specific example embodiments, the first terminal device 210-1 may be located within the serving area 250-1 at a first time point, and then moves out of the serving area 250-1 at a second time point.

Further, in the specific example of FIG. 2, any of the second terminal device 220, the access network device 230 and the core network device 240 may generate a configuration to trigger a procedure for identifying the first terminal deice 210. Additionally, in the configuration, the area of interests, especially, spatial area of interests (spatial area of interest 260 as illustrated in FIG. 2), may be indicated.

The communications in the communication environment 200 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols.

It is to be understood that the numbers and their connections of access network device, terminal device, core network device, serving area are only for the purpose of illustration without suggesting any limitations. The communication environment 200 may include any suitable access network device, terminal device, core network device and serving area adapted for implementing embodiments of the present disclosure.

### Example Processes

It should be understood that although feature(s)/operation(s) are discussed in specific example embodiments separately, unless clearly indicated to the contrary, these feature(s)/operation(s) described in different example embodiments may be used in any suitable combination.

It is clarified that the related devices during a specific communication procedure discussed herein should be coordinated. In other words, the related devices during a specific communication procedure should have common understanding about configuration, parameter and so on. Such common understanding may be implemented by any suitable interactions between the related devices or the related devices applying the same rule/policy (for example, rule/policy stipulated by the wireless organization, such as, 3GPP). In the following, although some operations are described from a perspective of one communication device, it is to be understood that the corresponding operations should be performed by another communication device during this specific communication procedure. Merely for brevity, some of the same or similar contents are omitted here.

In addition, in the following description, some interactions are performed among the related communication devices. It is to be understood that the interactions may be implemented either in one single signaling/message or multiple signaling/messages, including radio resource control (RRC) message, DCI message, MAC CE, NAS signaling/message and so on. The present disclosure is not limited in this regard.

Example processes for different scenarios will be discussed as below.

### Example Processes for Triggering to Broadcast the Presences/Identification Information

According to some example embodiments of the present disclosure, specific condition(s) for trigger a first terminal device 210 to broadcast the presences/identification information (referred to as “presence message” or “remote identification” sometimes) are well defined.

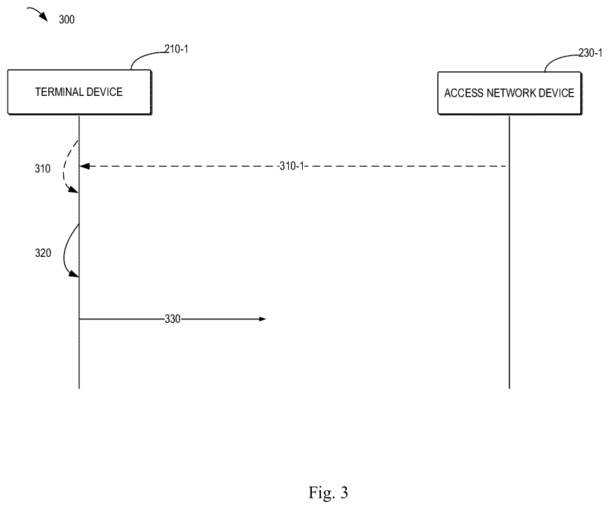

Principle and implementations of the present disclosure will be described in detail below with reference to FIG. 3. FIG. 3 shows a signaling chart illustrating a process 300 of communication according to some example embodiments of the present disclosure. For the purpose of discussion, the process 300 will be described with reference to FIG. 2. The process 300 may involve the first terminal device 210-1 and the access network device 230-1.

It is to be clarified that the implementation of process 300 is not limited to the interaction between the first terminal device 210-1 and the access network device 230-1. For example, in one alternative example embodiment, the process 300 involves the first terminal device 210-2 and the access network device 230-2. In another alternative example embodiment, the process 300 involves the first terminal device 210-1/210-2 and the second terminal device 220-1/220-2, where the second terminal device 220-1/220-2 functions as an aerial node, a UxNB, a master node.

In operation, the first terminal device 220-1 obtains 310 a broadcast condition. In some example embodiments, the broadcast condition is pre-defined at the first terminal device 210-1. More specifically, the communication network 200 may pre-define the broadcast condition, or the communication standards (such as, 3GPP standards) may stipulate the broadcast condition. In this event, the broadcast condition may be represented as file, program, or instructions in a local storage device of the first terminal device 210-1. In this way, the first terminal device 210-1 may obtain the broadcast condition without any additional message interaction.

Alternatively, the first terminal device 210-1 may obtain the broadcast condition from a further device. In the specific example of FIG. 3, the first terminal device 210-1 receives 310-1 a first configuration indicating the broadcast condition from the access network device 230-1. In one specific example embodiments, the first configuration is transmitted in an RRC configuration message. Alternatively, in another specific example embodiments, the first configuration is transmitted in an RRC reconfiguration.

According to some example embodiments of the present disclosure, the broadcast condition may be associated with at least one factor. One example factor is a connection status between the first terminal device 210-1 an access network device 230-1. Another example factor is a time interval since a last transmission of an identification message of the first terminal device 210-1. A further example factor may be a location of the terminal device 210-1. The other example factor may be an indication from an upper layer of the first terminal device 210-1.

It should be appreciated that the above factors are given for the purpose of illustration without suggesting any limitations. In other example embodiments, any suitable factors that may well stipulate the broadcast condition also may be used. Further, the above factors and the other suitable factors may be used separately or in combination.

Next, the first terminal device 210-1 determines 320 whether the broadcast condition is satisfied. If the first terminal device 210-1 determines that the broadcast condition is satisfied, the first terminal device 210-1 broadcasts the identification message of the first terminal device 210-1. Additionally, in some embodiments, the identification message is a RRC message and transmitted via a sidelink transmission or PC 5 interface. The detailed processes will be disused with reference to the following embodiments.

In some embodiments, the first terminal device 210-1 determines that the broadcast condition is satisfied if a connection status between the first terminal device 210-1 and the access network device 230-1 fails to satisfy a connection requirement.

Additionally, the connection requirement may be associated with one or more specific parameters or events. Accordingly, the first terminal device 210-1 may evaluate related parameters and detect related event to determine whether the connection status fails to satisfy the connection requirement.

In some embodiments, the first terminal device 210-1 determines that the broadcast condition is satisfied when the connection status fails to satisfy the connection requirement for a certain period. That is to say, the first terminal device 210-1 determines to broadcast the identification message when the broadcast condition has been satisfied for a certain period.

Specifically, in some embodiments, the first terminal device 210-1 determines that the connection status fails to satisfy the connection requirement (for a certain period) in response to at least one of the following:
a signal quality between the first terminal device 210-1 and the access network 230-1 device being lower than a quality threshold; especially when the first terminal device 210-1 is in a connected state;
a currently-measured signal quality being lower than a previously-measured signal quality;
a determination that a quality of communication condition being degreed;
detecting a physical layer failure; especially when the first terminal device 210-1 is in a connected state;
detecting a radio link failure; especially when the first terminal device 210-1 is in a connected state;
leaving a connected state; especially when the first terminal device 210-1 is not in a connected state;
entering into an idle state; especially when the first terminal device 210-1 is not in a connected state;
entering any cell selection state; especially when the first terminal device 210-1 is not in a connected state; or
being camped on an any cell; especially when the first terminal device 210-1 is not in a connected state.

Some details about the connection requirement are discussed as below. In some embodiments, the signal quality between the first terminal device 210-1 and the access network 230-1 device is determined by measuring a downlink reference signal. Further, the signal quality may be represented by any suitable parameters, including but not limited to, reference signal received quality (RSRQ), signal to noise plus interference power ratio (SNIR), received signal strength indication (RSSI) and so on.

In some embodiments, the first terminal device 210-1 may determine that there is a physical layer failure upon receiving N consecutive “out-of-sync” indications or upon starting of T310.

In some embodiments, the first terminal device 210-1 may determine that there is a radio layer failure upon an expiry of T310.

In some embodiments, whether the terminal device 210-1 leaves the connected state also may be evaluated and detected according to one or more specific parameters or events. Specifically, in some embodiments, the first terminal device 210-1 determines that the first terminal device 210-1 leaves the connected state in response to at least one of the following:
a radio link failure,
a beam failure,
an initiation of RRC re-establishment procedure,
an RRC re-establishment procedure failure,
a cell selection,
a cell reselection,
a handover failure,
a reception of handover command, or
a random access procedure failure.

Alternatively, or in addition, the first terminal device 210-1 determines that the broadcast condition is satisfied if a time interval since a last transmission of an identification message of the first terminal device 210-1 exceeds a period threshold.

Alternatively, or in addition, the first terminal device 210-1 determines that the broadcast condition is satisfied if the first terminal device 210-1 enters into the specific spatial area. In one specific example embodiments, the specific spatial area may be identified by at least one of zone id, latitude, longitude, and altitude. In another example embodiments, the spatial area may be represented by at least one of the following: geographic area, list of cells, next generation radio access network (NG-RAN) node(s) and/or tracking area identit(ies) (TAIs)), distance between the first terminal device 210 and a reference location (such as, a location of the second terminal device 220-1).

Alternatively, or in addition, the first terminal device 210-1 determines that the broadcast condition is satisfied if the first terminal device 210-1 receives an indication from an upper layer of the first terminal device 210-1, where the indication instructs the first terminal device 210-1 to broadcast the identification message of the first terminal device 210-1. In one specific embodiment, the indication is an application-layer indication and used to instruct the first terminal device 210-1 to switch into a broadcast mode.

Optionally, in some embodiments, if the first terminal device 210-1 receives the indication and switched into a broadcast mode/manner, in order to keep the consistency understanding about the behavior of the first terminal device 210-1, the first terminal device 210-1 will inform the access network device 230-1. Specifically, in some embodiments, upon receiving the indication from the upper layer, the first terminal device 210-1 transmits a first message to the access network device 230-1, where the first message indicates a stop of transmitting the identification message from the first terminal device 210-1 to the access network device 230-1. In other word, a unicast transmission of the identification message from the first terminal device 210-1 to the access network device 230-1 is stopped.

Alternatively, in some embodiments, upon receiving the indication from the upper layer, the first terminal device 210-1 transmits a first message to the access network device 230-1, where the first message indicates a start of broadcasting the identification message indicating the identification of the first terminal device 210.

In this way, the access network device 230-1 will be informed that the first terminal device 210-1 will not perform a unicast transmission any more. Further, as the first terminal device 210-1 starts to broadcast the identification message, which means that the access network device 230-1 may collect the broadcasted identification message from other device (such as, the second terminal device 220-1 which receives the broadcasted identification message).

Further, the identification message may comprise any suitable parameters, such that the first terminal device 210-1 may be well identified. In some embodiments, the identification message comprises at least one of the following:
a UAS identification of the first terminal device 210-1,
aircraft information of the first terminal device 210-1, associated with at least one of latitude, longitude and barometric pressure altitude,
aircraft information of a control station for the first terminal device 210-1, associated with at least one of latitude and longitude, barometric pressure altitude of the control station,
a time mark identifying the coordinated universal time (UTC) time of applicability of a position source output,
an indication of the emergency status of the UAS,
a service preference,
UAV data of the first terminal device 210-1,
UAV controller data of the first terminal device 210-1,
paring information of the first terminal device 210-1 and a controller of the first terminal device 210-1, or
a cause for broadcasting the identification message.

In some embodiments, the cause for broadcasting the identification message may be one of the following: losing the connection to the network/internet, time interval since a last transmission of an identification message of the first terminal device 210-1 exceeding a period threshold, entering into a specific area, receiving an indication from an upper layer and so on.

In some embodiments, the UAV data may be at least one of the following: a unique identity (such as, a 3GPP identity), UE capability of the UAV, make & model, serial number, take-off weight, position, owner identity, owner address, owner contact details, owner certification, take-off location, mission type, route data, operating status and so on.

In some embodiments, the UAV controller data may be at least one of the following: a unique identity (this may be a 3GPP identity), UE capability of the UAV controller, position, owner identity, owner address, owner contact details, owner certification, UAV operator identity, UAV operator license, UAV operator certification, UAV pilot identity, UAV pilot license, UAV pilot certification, flight plan and so on.

Further, the UAS identification may be represented diversely. Specifically, in some embodiments, the UAS identification may be represented to be one of the following:
a CAA-Level UAV ID of the first terminal device 210-1,
a serial number of the first terminal device 210-1,
a session identity,
an international mobile equipment identity,
a mobile station international subscriber directory number,
an IP address, or
a MAC address.

The broadcast of the identification message (which may be considered as flight information) may be triggered by proper condition. Further, by using the broadcasted identification message, the second terminal device 210-1 may avoid a potential collision with the first terminal device 210-1. Further, even if the first terminal device 210-1 is out of coverage of the access network device 230-1, the access network device 230-1 also may obtain the identification message from the second terminal device 220-1, such that an effect collision avoidance or tracking may be performed.

### Example Processes for Collecting Identification Messages

According to some example embodiments of the present disclosure, the second terminal device 220 may receive a second configuration (also referred to as “UAS identification request” sometimes) from a network device 405 (either an access network device 230 or a core network device 240 as illustrated in FIG. 2) via a RRC transmission or a NAS transmission. Based on the received second configuration, the second terminal device 220 may transmit a report comprising at least one received identification message (also referred to as “UAS presence report” sometimes) to the network device 405 via a RRC transmission or a NAS transmission. In this way, the first terminal device 210-1 may be well identified by the network device 405.

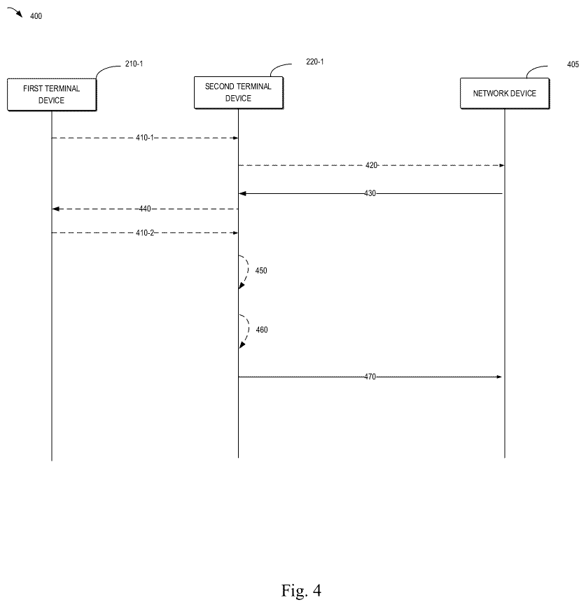

Principle and implementations of the present disclosure will be described in detail below with reference to FIG. 4. FIG. 4 shows a signaling chart illustrating a process 400 of communication according to some example embodiments of the present disclosure. For the purpose of discussion, the process 400 will be described with reference to FIG. 2. The process 400 may involve the second terminal device 220-1 and the network device 405 (i.e., either the access network device 230-1 or the core network device 240 as illustrated in FIG. 2)

It is to be clarified that the implementation of process 400 is not limited to the interaction between the first terminal device 210-1 and the access network device 230-1/the core network device 240. For example, in one alternative example embodiment, the process 400 involves the second terminal device 220-2 and the access network device 230-2.

In operation, the second terminal device 220-1 receives 430 the second configuration from the network device 405, where the second configuration is used for triggering the second terminal device 220-1 to transmit a report comprising at least one received identification message.

Next, the second terminal device 220-1 may determine 460 whether a forward condition is satisfied. If the forward condition is satisfied, the second terminal device 220-1 transmits 470 the report comprising at least one identification message to the network device 405.

According to some example embodiments of the present disclosure, the second configuration may define parameters/rule associated with the collecting procedure of the identification message, the transmission manner of the report and the forward condition, as will be discussed below.

In some embodiment, the network device 405 may indicate its interests (i.e., identification objects information) in the second configuration, such as,
aircraft information of interests associated with a terminal device 210, comprising at least one of latitude, longitude and barometric pressure altitude,
aircraft information of interest associated with a control station, comprising at least one of latitude and longitude, barometric pressure altitude, or
spatial area of interests; also referred to as “target area information”, or “area of interests” for brevity.

In this way, the network device 405 may reduce the unnecessary reporting of the identification message, while achieve a feasibility of the reporting of the identification message.

Additionally, in some embodiments, the spatial area of interests may be represented by at least one of the following: zone id, latitude, longitude, and altitude, geographic area, list of cells, NG-RAN node(s) and/or TAIs, distance between the first terminal device 210-1 and the second terminal device 220-1.

Alternatively, or in addition, the network device 405 may indicate a value of a timer, where the value of timer is associated with a transmission interval between two successive reports. In this way, the network device 405 may avoid a frequently reporting of the identification message.

Specifically, in some embodiments, the second terminal device 220-1 is configured to transmit the report if a timer started in response to transmitting a latest report is not running and starts or restarts the timer in response to transmitting the report.

In one specific example embodiment, a Timer B corresponding to the above discussed timer may be defined. The example definition of Time B is illustrated in below Table 2.

TABLE 2
definition of Time B

| Timer | Start | Stop |
|---|---|---|
| Timer B | Upon transmitting | Upon releasing UAS identification |
| | UEAssistanceInformation message | configuration during the connection |
| | with UAS presence report. | re-establishment/resume procedures, and upon |
| | | receiving UAS identification configuration set |
| | | to release. |

Further, in this specific example embodiment, if the current report (such as, UAS presence report) is different from the one indicated in the last transmission of the report (which may be comprised in UEAssistanceInformation message) and timer B is not running, the second terminal device 220-1 may start or restart timer B with the configured timer value upon transmitting the report.

Alternatively, or in addition, the network device 405 may indicates a valid time window (referred to as “a first valid time window” or “a valid response time”) for identifying a first terminal device 210. Specifically, during the first valid time window, the second terminal device 220-1 may collect the identification message and/or transmit the report to the network device 405.

Alternatively, or in addition, the network device 405 may indicate a transmission manner (referred to as “report manner”) to be used by the second terminal device 220-1 for transmitting the report. One example transmission manner is one-shot transmission, which means that the second terminal device 220-1 only needs to transmit the report once and optionally according to the configured first valid time window. Another example transmission manner is a periodical transmission, which means that the second terminal device 220-1 should transmit the report periodically. Additionally, the periodicity for transmitting the report may be defined to be a default value. Specifically, the default value may be stipulated by a wireless organization (such as, 3GPP), or a network operator, a service provider and so on. Alternatively, the periodicity is configured by the second configuration. The further example transmission manner is an event-trigged/based transmission. The other example transmission manner is an immediate transmission, which means that the second terminal device 220-1 should transmits the report immediately upon receiving the second configuration.

Additionally, in case that the transmission manner is an event-trigged/based transmission, the second configuration may further indicate information about at least one event which triggers an event-based transmission of the report. In one specific example embodiments, the event may be a number of received identification messages exceeding a number threshold. In this event, the second configuration may indicate the number threshold. In another specific example embodiment, the event may be the first terminal device 210-1 entering into a specific area. In this event, the second configuration may indicate the specific area. In another specific example embodiment, the event may be a distance between the first terminal device 210-1 and the second terminal device 220-1 exceeding a distance threshold. In this event, the second configuration may indicate the distance threshold.

It should be appreciated that the above example events are given for the purpose of illustration without suggesting any limitations. In other embodiments, any suitable event may be used for defining the trigger for transmitting the event-trigged transmission. Further, the above illustrated events and the other suitable events may be used separately or in combination.

As discussed previously, the second terminal device 220-1 may collect the identification message based on the second configuration.

As illustrated in FIG. 4, the second terminal device 220-1 receives 410-2 the identification message from the first terminal device 220-1 (it is to be understood that the second terminal device 220-1 actually may receive more than one identification message from a plurality of first terminal devices 210). Optionally, the second terminal device 220-1 may transmit 440 a message to trigger the first terminal device 210-1 to broadcast its identification message (such procedure will be discussed in detail in the following).

In some embodiment, the second terminal device 220-1 report all the received identification messages (i.e., all identified UAS(s)).

Alternatively, in some embodiment, the second terminal device 220-1 may filter 450 the at least one identification message received from the at least one first terminal device 210 and transmit the report comprising the filtered at least one identification message. In one specific example embodiment, in case that the second configuration indicates the interests (such as, aircraft information of interests, the aircraft information of interest and spatial area of interests), the second terminal device 220-1 may filter the at least one identification message based on the interests indicated by the second configuration. Alternatively, or in addition, in another specific example embodiment, in case that the second configuration indicates the number threshold, the second terminal device 220-1 may filter the at least one identification message based on the number threshold. Alternatively, or in addition, in another specific example embodiment, in case that the second configuration indicates the distance threshold, the second terminal device 220-1 may filter the at least one identification message based on the distance threshold.

It is should be understood that the above example filtering procedures are for the purpose of illustration without suggesting any limitations. The second terminal device 220-1 may filter the at least one identification message based on any suitable rules. Further, such filtering rules may be used separately or in combination.

According to some example embodiments of the present disclosure, the forward condition may be associated with at least one factor. One example factor is a number of received identification messages. Another example factor is a number of the filtered at least one identification message. A further example factor may be a distance between the first terminal device 210-1 and the second terminal device 220-1.

Accordingly, the second terminal device 220-1 determines 320 whether the forward condition is satisfied based on the pre-defined forward condition. Specifically, in some embodiments, the second terminal device 220-1 determines that the forward condition is satisfied if a number of received identification messages exceeds the number threshold. Alternatively, or in addition, in some other embodiments, the second terminal device 220-1 determines that the forward condition is satisfied if a number of the filtered at least one identification message exceeds the number threshold. Alternatively, or in addition, in some further embodiments, the second terminal device 220-1 determines that the forward condition is satisfied if the first terminal device 210-1 enters into the specific area. Alternatively, or in addition, in some further embodiments, the second terminal device 220-1 determines that the forward condition is satisfied if a distance between the first terminal device 210-1 and the second terminal device 220-1 exceeds a distance threshold.

It should be appreciated that the above factor are given for the purpose of illustration without suggesting any limitations. In other example embodiments, any suitable factors that may well stipulate the forward condition also may be used. Further, the above factor and the other suitable factors may be used separately or in combination.

In some embodiments, the at least one identification message is received prior to receiving the second configuration. As illustrated in FIG. 4, the second terminal device 220-1 receives 410-1 at least one identification message prior to receiving the second configuration. Additionally, in some embodiments, the second terminal device 220-1 transmits 420 a second message comprising an availability indicator to the access network device 230-1. Additionally, in some embodiments, the network device 405 may generate the second configuration upon receiving the availability indicator.

In some embodiments, the availability indicator is provided within NR re-establishment, reconfiguration, such as, in RRCSetupComplete message or RRCResumeComplete message during connection establishment. Alternatively, in some other embodiments, the availability indicator can be included in some uplink RRC messages, for example, in an RRCReconfigurationComplete message, an RRCReestablishmentComplete message, or a UEInformationResponse message, at every transition to RRC Connected mode even though the logging or collecting period has not ended.

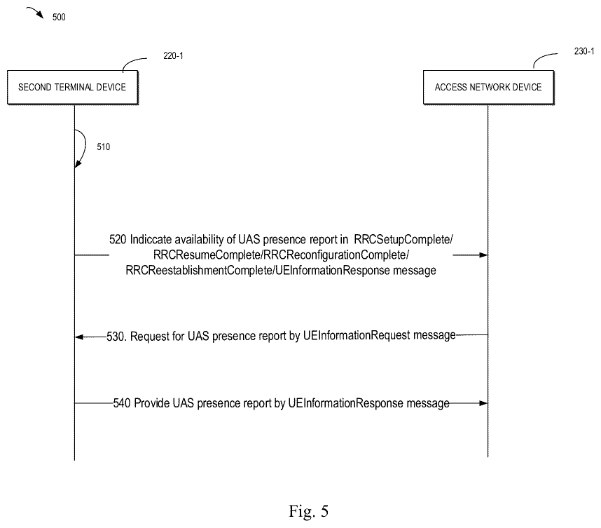

Reference is now made to FIG. 5, which illustrates a signaling chart 500 of a process for communication according to some embodiments of the present disclosure.

As illustrated in FIG. 5, the second terminal device 210-1 has collected 510 at least one identification message from at least one first terminal device 210 (such as, via a UAS presence collection). Then, the second terminal device 220-1 indicate 520 the availability of the at least one identification message (such as, a UAS presence report) in a message of one of the following: an RRCSetupComplete message, an RRCResumeComplete message, an RRCReconfigurationComplete message, an RRCReestablishmentComplete message, an UEInformationResponse message.

Next, the access network device 230-1 may generate and transmit the second configuration to the second terminal device 220-1. Specifically, the access network device 230-1 transmit 530 a request for UAS presence report by a UEInformationRequest message. Accordingly, the second terminal device 220-1 may transmit report to the access network device 230-1. Specifically, the second terminal device 220-1 provide 540 the report (i.e., a UAS presence report) by UEInformationResponse message to the access network device 230-1.

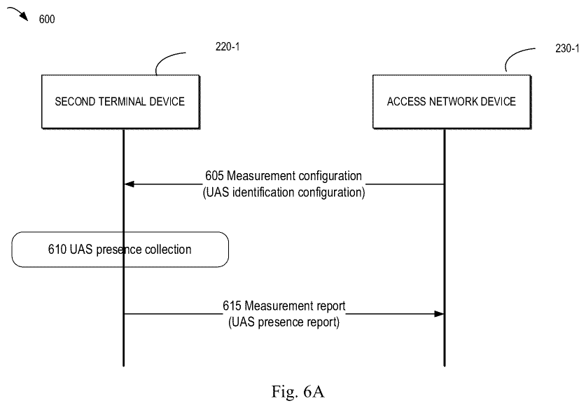

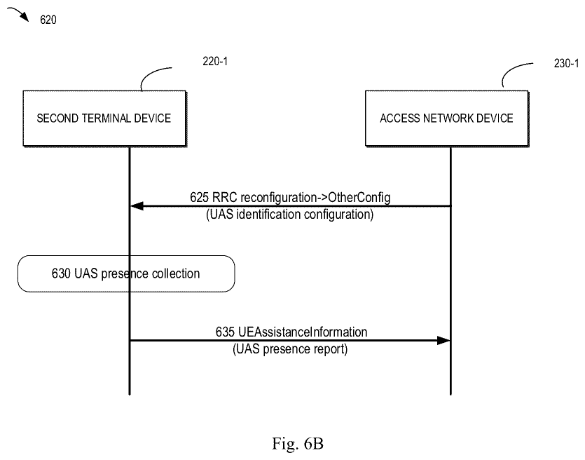

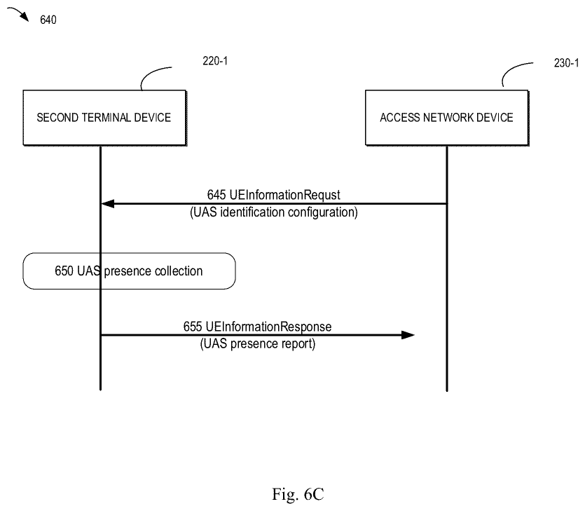

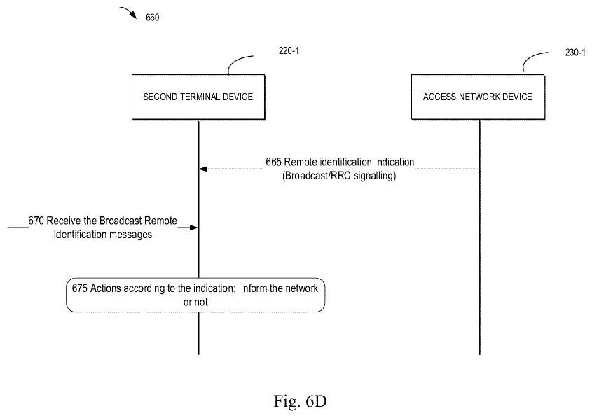

In addition, the above procedure may be performed during any suitable procedures. In one specific example embodiment, the network device 405 is the access network device 230-1, the second configuration is a measurement configuration received from the access network device 230-1, and the report is a measurement report. Reference is now made to FIG. 6A, which illustrates a signaling chart 600 of a process for communication according to some embodiments of the present disclosure.

As illustrated in FIG. 6A, the access network device 230-1 transmits 605 the second configuration (such as, a measurement configuration (UAS identification configuration) to the second terminal device 220-1. Then the second terminal device 220-1 collects 610 at least one identification message from at least one first terminal device 210 (such as, via a UAS presence collection). After that, the second terminal device 220-1 transmits 615 the report comprising at least part of the collected identification message to the access network device 230-1 (such as, a measurement report (UAS presence report).

In some embodiment, the measurement configuration may comprise all the information as discussed with regards to the second configuration. In this specific example embodiment, the measurement configuration also comprises a report configuration. In some embodiments, the report configuration includes Trigger Type (such as, periodicity or event). Further, in case that the Trigger Type is set to be periodicity, the report configuration further defines a periodicity for transmitting the report (such as, Report period).

In case that the Trigger Type is set to be event, the report configuration further defines the number threshold (e.g., UAS Number threshold) and Time-to-trigger. Below Table 3 illustrates example of event definition in case that the Trigger Type is event. The first terminal device 21001 is considered to detect/determine the event when a entering condition is fulfilled. In case of the first terminal device 210-1 detect/determine the occurrence event for a time period (be represented as Time-to-trigger) (i.e., the event has lasted for the certain period), the first terminal device 210-1 is triggered to transmit the report.

TABLE 3
example of event definition

| Event X1 (The number of identified | Event X2 (The number of identified |
|---|---|
| UAS is above a threshold) | UAS is below a threshold) |
| The UE shall: | The UE shall: |
| Consider the entering condition for this | Consider the entering condition for this |
| event to be satisfied when condition | event to be satisfied when condition |
| X1-1, as specified below, is fulfilled; | X2-1, as specified below, is fulfilled; |
| Consider the leaving condition for this | Consider the leaving condition for this |
| event to be satisfied when condition | event to be satisfied when condition |
| X1-2, as specified below, is fulfilled; | X2-2, as specified below, is fulfilled; |
| Inequality X-1 (Entering condition) | Inequality X-1 (Entering condition) |
| Ms − Hys > Thresh | Ms + Hys < Thresh |
| Inequality X-2 (Leaving condition) | Inequality X-2 (Leaving condition) |
| Ms + Hys < Thresh | Ms − Hys > Thresh |
| The variables in the formula are defined | The variables in the formula are defined |
| as follows: | as follows: |
| Ms is the collected Aerial UE number. | Ms is the collected Aerial UE number. |
| Hys is the hysteresis parameter | Hys is the hysteresis parameter |
| Thresh is the threshold parameter for this | Thresh is the threshold parameter for this |
| event. | event. |

It is to be clarified that the above events (i.e., Event X1, Event X2) are only for the purpose of illustration without suggesting any limitations. In some other example embodiments, more or less events may be defined. Further, such events may be stipulated by a wireless organization (such as, 3GPP), or a network operator, a service provider and so on. Moreover, one or more defined events may be used separately or in combination.

Alternatively, in another specific example embodiment, the network device 405 is the access network device 230-1, the second configuration is a RRC reconfiguration message received from the access network device 230-1, and the report is transmitted as UE assistance information. Reference is now made to FIG. 6B, which illustrates a signaling chart 620 of a process for communication according to some embodiments of the present disclosure.

As illustrated in FIG. 6B, the access network device 230-1 transmits 625 the second configuration (such as, an RRC reconfiguration->OtherConfig (UAS identification configuration) to the second terminal device 220-1. Then the second terminal device 220-1 collects 630 at least one identification message from at least one first terminal device 210 (such as, via a UAS presence collection). After that, the second terminal device 220-1 transmits 635 the report comprising at least part of the collected identification message to the access network device 230-1 (such as, a UEAssistanceInformation (UAS presence report)).

Alternatively, in another specific example embodiment, the network device 405 is the access network device 230-1, the second configuration is a UE information request received from the access network device, and the report is comprised in a UE information response. Reference is now made to FIG. 6C, which illustrates a signaling chart 640 of a process for communication according to some embodiments of the present disclosure.

As illustrated in FIG. 6C, the access network device 230-1 transmits 645 the second configuration (such as, a UEInformationRequst (UAS identification configuration)) to the second terminal device 220-1. Then the second terminal device 220-1 collects 650 at least one identification message from at least one first terminal device 210 (such as, via a UAS presence collection). After that, the second terminal device 220-1 transmits 655 the report comprising at least part of the collected identification message to the access network device 230-1 (such as, a UEInformationResponse (UAS presence report)).

Alternatively, in a further specific example embodiment, the network device 405 is the access network device 230-1, the second configuration is a remote identification indication message received from the access network device 230-1, and the report is comprised in a Remote Identification messages. Reference is now made to FIG. 6D, which illustrates a signaling chart 660 of a process for communication according to some embodiments of the present disclosure.

As illustrated in FIG. 6D, the access network device 230-1 transmits 645 the second configuration (such as, remote identification indication via a broadcast manner or an RRC signalling)) to the second terminal device 220-1. Then the second terminal device 220-1 receive 670 the broadcast remote identification messages from at least one first terminal device 210 (such as, via a UAS presence collection). After that, the second terminal device 220-1 may perform 675 actions according to the indication, for example, whether to inform the access network device 230-1 about the broadcast remote identification messages.

In some embodiment, the remote identification indication may comprise all the information as discussed with regards to the second configuration. In this specific example embodiment, the remote identification indication also may indicate following actions upon the second terminal device 220-1 receiving the broadcast remote identification messages:
For flight path update/arrangement/organization: No Transmit to the network device 405;
Transmit to the network device 405 for fight plan update/arrangement/organization.

In this way, an efficient resource management, fight path organization, collision avoidance or tracking may be achieved.

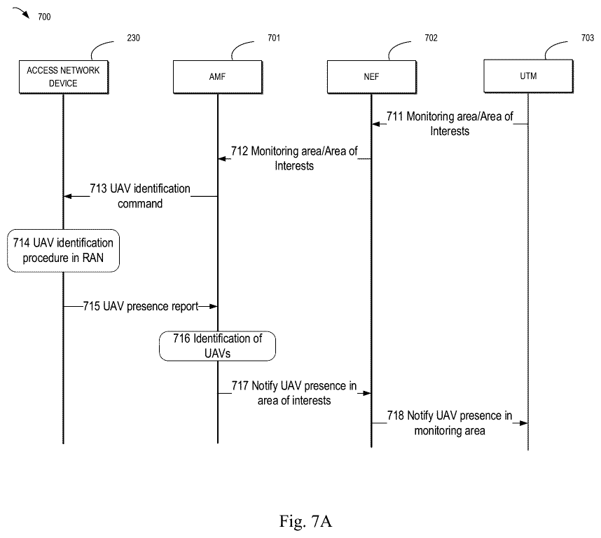

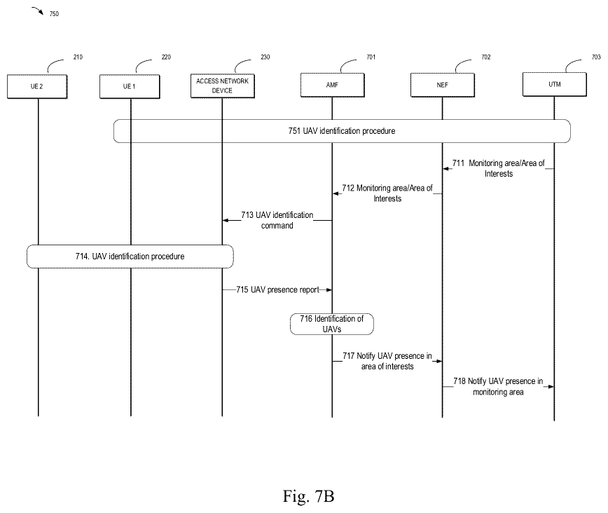

In addition to the above, the access network device 230-1 also may generate the second configuration based on a third configuration from a core network device 240. Some example process will be discussed with reference to FIGS. 7A and 7B, which illustrate signaling charts of processes 700 and 750 for communication according to some embodiments of the present disclosure, where FIG. 7B is a detailed implementation of FIG. 7A. When describing FIGS. 7A and 7B, same actions are illustrated with same reference numbers. For the purpose of discussion, the processes 700 and 750 will be described with reference to FIG. 2. The processes 700 and 750 may involve the first terminal device 210, the second terminal device 220, the access network device 230, the AMF 701, the NEF 702 and the UTM 703.

As illustrated in the FIGS. 7A and 7B, the UTM 703 sends 711 subscribed monitoring area to the NEF 702 to subscribe the identity list of authorized UAV(s) (such as, the list of authorized first terminal device 210) in the target area as a monitoring event. Additionally, the target area information (e.g., list of cells, geographic area) is included.

The NEF 702 identifies 712 the AMF 701 based on the target area information, and subscribes the event exposure to AMF 701, while indicates a request for the identity list of authorized UAV(s) and the associating target area (e.g., list of cell(s), the access network device 230 and/or TAI(s)). Then AMF 701 indicates 713 the access network device 230 to perform a UAV identification procedure or report the UAV presence (i.e., transmit the third configuration). The UAV identification procedure is performed 714 as discussed previously in the present discourse (it is to be understood that the UAV identification procedure also may be performed before receiving the third configuration).

After the UAV identification procedure, the access network device 230 forward 715 the UAV presence report to AMF 701. The AMF 701 collects 716 the UAV(s) in the target area base on the report from the access network device 230.

In one specific example of FIG. 7B, a UAV identification procedure may be performed 751 at the beginning. In this event, the total identified UAV(s) is consisted of two parts: one is the UAV(s) collected base on the report from the access network device 230, another is the UAV(s) identified during the UAV identification procedure at the beginning.

In the following, the AMF 701 sends 717 the event report to notify UAV presence in area of interest, and the event report includes the identity list of authorized UAV(s). Then, the NEF 702 combines the results from all the involved AMF 701, and forwards 718 the combined result to the UTM 703 the list of authorized UAV(s).

Additionally, after the UTM 703 receiving the identity list of the authorized UAV(s), the UTM 703 may initiate the location procedure for each UAV, where the periodic location can be used for tracking each UAV.

In this way, a core network device (such as, any of the AMF 701, the NEF 702 and the UTM 703) may trigger an identification procedure to achieve an efficient resource management, fight path organization, collision avoidance or tracking.

### Example Processes for Discovering Procedure

According to some example embodiments of the present disclosure, the second terminal device 220 may initiate the identification procedure with the first terminal device 210.

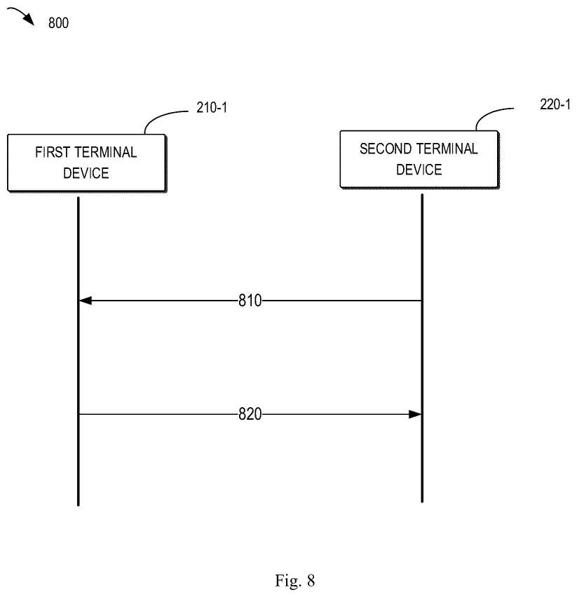

Principle and implementations of the present disclosure will be described in detail below with reference to FIG. 8. FIG. 8 shows a signaling chart illustrating a process 800 of communication according to some example embodiments of the present disclosure. For the purpose of discussion, the process 800 will be described with reference to FIG. 2. The process 800 may involve the first terminal device 210-1 and the second terminal device 220-1.

It is to be clarified that the implementation of process 800 is not limited to the interaction between the first terminal device 210-1 and the second terminal device 220-1. For example, in one alternative example embodiment, the process 800 involves the first terminal device 210-2 and the second terminal device 220-2. Further, in some embodiments, the second terminal device 220-1/220-2 functions as an aerial node, a UxNB, a master node.

In operation, the first terminal device 210-1 receives 810 an identification request indicating spatial area of interests. In some embodiments, the identification request is transmitted via a broadcast manner/channel. Additionally, in some embodiments, the identification request is transmitted via a sidelink transmission or a PC 5 interface.

Further, in some embodiments, the spatial area of interests may be represented by at least one of the following: zone id, latitude, longitude, and altitude, geographic area, list of cells, NG-RAN node(s) and/or TAIs, distance between the first terminal device 210-1 and the second terminal device 220-1.

Additionally, in some embodiments, the identification request further comprises at least one of the following:
a presence identify indication,
information about the second terminal device 220-1, or
a second valid time window to be used by the first terminal device 210-1 for transmitting the identification response; also referred to as a valid response time

In some embodiments, the information about the second terminal device 220-1 may be represented to be network information of the second terminal device 220-1, including but not limited to, RAN node information, public land mobile network (PLMN) information or other network information. Alternatively, the information about the second terminal device 220-1 may be an identity of the second terminal device 220-1. The identity of the second terminal device 220-1 may be one of the following:
a CAA-Level UAV ID of the second terminal device 220-1,
a serial number of the second terminal device 220-1,
a session identity,
an international mobile equipment identity of the second terminal device 220-1,
a mobile station international subscriber directory number of the second terminal device 220-1,
an IP address of the second terminal device 220-1, or
a MAC address of the second terminal device 220-1.

Then, the first terminal device 210-1 transmit 820 an identification response to the second terminal device 220-1.

Further, the identification response may comprise any suitable parameters, such that the first terminal device 210-1 may be well identified. In some embodiments, the identification response comprises at least one of the following:
a UAS identification of the first terminal device 210-1,
aircraft information of the first terminal device 210-1, associated with at least one of latitude, longitude and barometric pressure altitude,
aircraft information of a control station for the first terminal device 210-1, associated with at least one of latitude and longitude, barometric pressure altitude of the control station,
a time mark identifying the coordinated universal time (UTC) time of applicability of a position source output,
an indication of the emergency status of the UAS,
a service preference,
unmanned aerial vehicle (UAV) data of the first terminal device 210-1,
UAV controller data of the first terminal device 210-1, or
paring information of the first terminal device 210-1 and a controller of the first terminal device 210-1.

Further, the UAS identification may be represented diversely. Specifically, in some embodiments, the UAS identification may be represented to be one of the following:
a CAA-Level UAV ID of the first terminal device 210-1,
a serial number of the first terminal device 210-1,
a session identity,
an international mobile equipment identity,
a mobile station international subscriber directory number,
an IP address, or
a MAC address.

In this way, the first terminal device 210-1 may be well identified by the second terminal device 220-1, which achieves an efficient resource management, fight path organization, collision avoidance or tracking.

### Example Processes for Measurement Report

According to some example embodiments of the present disclosure, the second terminal device 220 may initialise the first terminal device 210-1 to report its location.

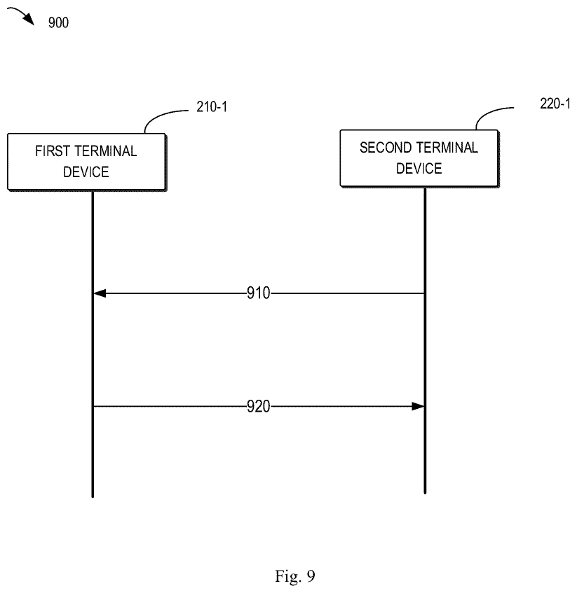

Principle and implementations of the present disclosure will be described in detail below with reference to FIG. 9. FIG. 9 shows a signaling chart illustrating a process 900 of communication according to some example embodiments of the present disclosure. For the purpose of discussion, the process 900 will be described with reference to FIG. 2. The process 900 may involve the first terminal device 210-1 and the second terminal device 220-1.

It is to be clarified that the implementation of process 900 is not limited to the interaction between the first terminal device 210-1 and the second terminal device 220-1. For example, in one alternative example embodiment, the process 900 involves the first terminal device 210-2 and the second terminal device 220-2. Further, in some embodiments, the second terminal device 220-1/220-2 functions as an aerial node, a UxNB, a master node.

In operation, the first terminal device 210-1 receives 910 a measurement configuration comprising information about at least one condition that triggers the first terminal device 210-1 to transmit a location report.

In some embodiments, the information about at least one condition comprises at least one of the following:
a height threshold,
a reference location, such as, a location of the second terminal device 220-1, or
a distance threshold between the first terminal device 210-1 and the second terminal device 220-1.

In one specific example embodiment, the measurement configuration comprises a report configuration, comprising at least one of the following: an Event threshold of a height threshold. Below Table 4 illustrates an example of event definition in case that the report configuration comprises the height threshold.

TABLE 4
example of event definition

| Event Y1 (The Aerial UE height is above | Event Y2 (The Aerial UE height is below |
|---|---|
| a threshold) | a threshold) |
| The UE shall: | The UE shall: |
| Consider the entering condition for this | Consider the entering condition for this |
| event to be satisfied when condition | event to be satisfied when condition |
| Y1-1, as specified below, is fulfilled; | H1-1, as specified below, is fulfilled; |
| Consider the leaving condition for this | Consider the leaving condition for this |
| event to be satisfied when condition | event to be satisfied when condition |
| Y1-2, as specified below, is fulfilled; | H1-2, as specified below, is fulfilled; |
| Inequality Y1-1 (Entering condition) | Inequality Y2-1 (Entering condition) |
| Ms − Hys > Thresh + Offset | Ms + Hys < Thresh + Offset |
| Inequality Y1-2 (Leaving condition) | Inequality Y2-2 (Leaving condition) |
| Ms + Hys < Thresh + Offset | Ms − Hys > Thresh + Offset |
| The variables in the formula are defined | The variables in the formula are defined |
| as follows: | as follows: |
| Ms is the Aerial UE height. | Ms is the Aerial UE height. |
| Hys is the hysteresis parameter. | Hys is the hysteresis parameter. |
| Thresh is a reference threshold parameter | Thresh is a reference threshold |
| or an absolute threshold parameter for | parameter or an absolute threshold |
| this event. | parameter for this event. |
| In case that the Thresh is a reference | In case that the Thresh is a reference |
| threshold parameter, further comprising | threshold parameter, further comprising |
| Offset, where Offset is the offset value to | Offset, where Offset is the offset value to |
| reference threshold to obtain the absolute | reference/absolute threshold to obtain the |
| threshold for this event. | absolute threshold for this event. |

It is to be clarified that the above events (i.e., Event Y1, Event Y2) are only for the purpose of illustration without suggesting any limitations. In some other example embodiments, more or less events may be defined. Further, such events may be stipulated by a wireless organization (such as, 3GPP), or a network operator, a service provider and so on. Moreover, one or more defined events may be used separately or in combination.

Alternatively, in another specific example embodiment, the measurement configuration comprises a report configuration, comprising at least one of the following: an Event threshold of a distance threshold and a reference location (such as, the location of the second terminal device 220-1), where the distance threshold is to be used for comparing with a distance between the first terminal device 210 and the reference location. Below Table 5 illustrates an example of event definition in case that the report configuration comprises the distance threshold.

TABLE 5
example of event definition

| Event Z1 (The distance between the | Event Z2 (The distance between the |
|---|---|
| Aerial UE and the reference location is | Aerial UE and the reference location is |
| above a threshold) | below a threshold) |
| The UE shall: | The UE shall: |
| Consider the entering condition for this | Consider the entering condition for this |
| event to be satisfied when condition | event to be satisfied when condition |
| Z1-1, as specified below, is fulfilled; | Z2-1, as specified below, is fulfilled; |
| Consider the leaving condition for this | Consider the leaving condition for this |
| event to be satisfied when condition | event to be satisfied when condition |
| Z1-2, as specified below, is fulfilled; | Z2-2, as specified below, is fulfilled; |
| Inequality Z1-1 (Entering condition) | Inequality Z2-1 (Entering condition) |
| Ms − Hys > Thresh + Offset | Ms + Hys < Thresh + Offset |
| Inequality Z1-2 (Leaving condition) | Inequality Z2-2 (Leaving condition) |
| Ms + Hys < Thresh + Offset | Ms − Hys > Thresh + Offset |
| The variables in the formula are defined | The variables in the formula are defined |
| as follows: | as follows: |
| Ms is the distance between the Aerial UE | Ms is the distance between the Aerial UE |
| and the reference location. | and the reference location. |
| Hys is the hysteresis parameter. | Hys is the hysteresis parameter. |
| Thresh is a reference threshold parameter | Thresh is a reference threshold parameter |
| or an absolute threshold parameter for | or an absolute threshold parameter for |
| this event. | this event. |
| In case that the Thresh is a reference | In case that the Thresh is a reference |
| threshold parameter, further comprising | threshold parameter, further comprising |
| Offset, where Offset is the offset value to | Offset, where Offset is the offset value to |
| reference threshold to obtain the absolute | reference threshold to obtain the |
| threshold for this event. | absolute threshold for this event. |

It is to be clarified that the above events (i.e., Event Z1, Event Z2) are only for the purpose of illustration without suggesting any limitations. In some other example embodiments, more or less events may be defined. Further, such events may be stipulated by a wireless organization (such as, 3GPP), or a network operator, a service provider and so on. Moreover, one or more defined events may be used separately or in combination.

In this way, an event-triggered reporting between terminal devices is achieved, which may achieve an assist resource management and collision avoidance or tracking.

### Example Methods

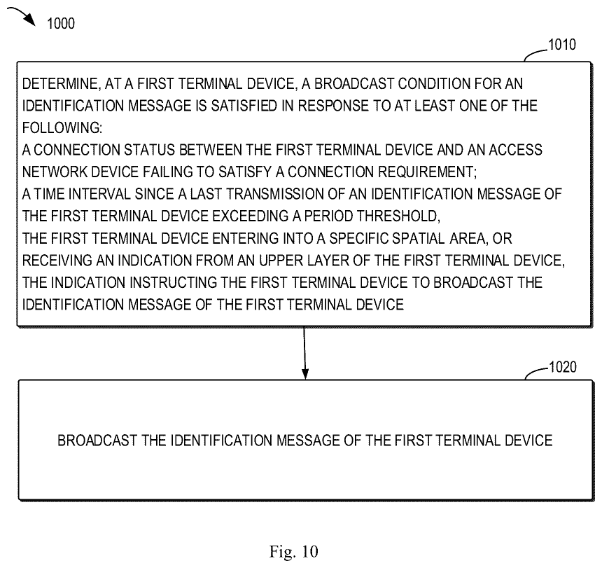

FIG. 10 illustrates a flowchart of an example method 1000 in accordance with some embodiments of the present disclosure. For example, the method 1000 can be implemented at the first terminal device 210 as shown in FIG. 2.

At block 1010, the first terminal device 210 determines that a broadcast condition for an identification message is satisfied in response to at least one of the following: a connection status between the first terminal device 210 and an access network device 230 failing to satisfy a connection requirement; a time interval since a last transmission of an identification message of the first terminal device 210 exceeding a period threshold, the first terminal device 210 entering into a specific spatial area, or receiving an indication from an upper layer of the first terminal device 210, the indication instructing the first terminal device 210 to broadcast the identification message of the first terminal device 210.

At block 1020, the first terminal device 210 broadcasts the identification message of the first terminal device 210.

In some embodiments, the first terminal device 210 determines that the connection status fails to satisfy the connection requirement in response to at least one of the following: a signal quality between the first terminal device 210 and the access network device 230 being lower than a quality threshold; detecting a physical layer failure; detecting a radio link failure; leaving a connected state; entering into an idle state; entering any cell selection state; or being camped on an any cell.

In some embodiments, the first terminal device 210 determines that the first terminal device 210 leaves the connected state in response to at least one of the following: a radio link failure, a beam failure, an initiation of radio resource control (RRC) re-establishment procedure, an RRC re-establishment procedure failure, a cell selection, a cell reselection, a handover failure, a reception of handover command, or a random access procedure failure.

In some embodiments, upon receiving the indication from the upper layer, the first terminal device 210 transmits a first message to the access network device 230, the first message indicating: a stop of transmitting the identification message of the first terminal device 210 to the access network device 230, or a start of broadcasting the identification message indicating the identification of the first terminal device 210.

In some embodiments, the identification message comprises at least one of the following: a UAS identification of the first terminal device 210, aircraft information of the first terminal device 210, associated with at least one of latitude, longitude and barometric pressure altitude, aircraft information of a control station for the first terminal device 210, associated with at least one of latitude and longitude, barometric pressure altitude of the control station, a time mark identifying the UTC time of applicability of a position source output, an indication of the emergency status of the UAS, a service preference, UAV data of the first terminal device 210, UAV controller data of the first terminal device 210, paring information of the first terminal device 210 and a controller of the first terminal device 210, or a cause for broadcasting the identification message.

In some embodiments, the UAS identification is one of the following: a serial number of the first terminal device 210, a CAA-Level UAV ID of the first terminal device 210-1, a session identity, an international mobile equipment identity, a mobile station international subscriber directory number, an IP address, a MAC address.

In some embodiments, the broadcast condition is pre-defined or obtained from a first configuration indicating the broadcast condition from the access network device 230.

In some embodiments, the first terminal device 210 transmits the identification message via a sidelink transmission or PC 5 interface.

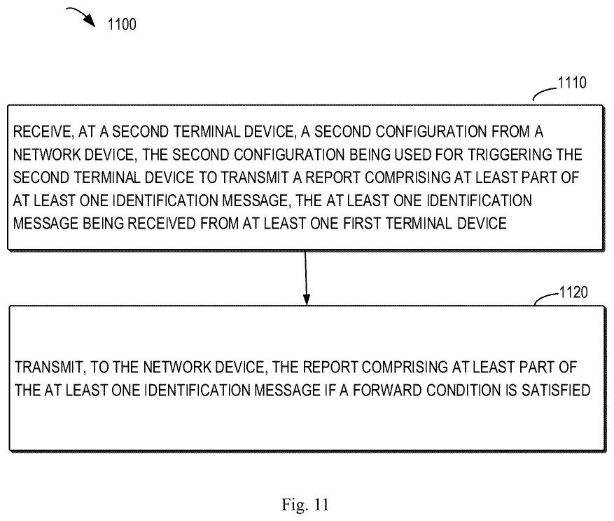

FIG. 11 illustrates a flowchart of an example method 1100 in accordance with some embodiments of the present disclosure. For example, the method 1100 can be implemented at the second terminal device 220 as shown in FIG. 2.

At block 1110, the second terminal device 220 receives a second configuration from a network device, the second configuration being used for triggering the second terminal device 220 to transmit a report comprising at least part of at least one identification message, the at least one identification message being received from at least one first terminal device 210.

At block 1120, the second terminal device 220 transmits, to the network device, the report comprising at least part of the at least one identification message if a forward condition is satisfied.

In some embodiments, the second configuration indicates at least one of the following: aircraft information of interests associated with a terminal device, comprising at least one of latitude, longitude and barometric pressure altitude, aircraft information of interest associated with a control station, comprising at least one of latitude and longitude, barometric pressure altitude, spatial area of interests, a first valid time window for identifying a first terminal device 210, a transmission manner to be used by the second terminal device 220 for transmitting the report, value of a timer, associated with a transmission interval between two successive reports, or information about at least one event which triggers an event-based transmission of the report.

In some embodiments, the second terminal device 220 filters, based on the second configuration, the at least one identification message received from the at least one first terminal device 210, and transmits the report comprising the filtered at least one identification message.

In some embodiments, the transmission manner is one of the following: a one-shot transmission, a periodical transmission, or an event-based transmission.

In some embodiments, the second terminal device 220 determines that the forward condition is satisfied in response to at least one of the following: a number of received identification messages exceeding a number threshold; a number of the filtered at least one identification message exceeding a number threshold; the first terminal device 210 entering into a specific area; or a distance between the first terminal device 210 and the second terminal device 220 exceeding a distance threshold.

In some embodiments, the network device is an access network device 230, the second configuration is a measurement configuration received from the access network device 230, and the report is a measurement report.

In some embodiments, the network device is an access network device 230, the second configuration is included in an RRC reconfiguration message received from the access network device 230, and the report is transmitted as UE assistance information.

In some embodiments, the second terminal device 220 transmits the report if a timer started in response to transmitting a latest report is not running, and restarts the timer in response to transmitting the report.

In some embodiments, the network device is an access network device 230, the second configuration is included in a UE information request received from the access network device 230, and the report is a UE information response.

In some embodiments, the network device is an access network device 230. Further, prior to receiving the second configuration, the second terminal device 220 receives the at least one identification message from at least one first terminal device 210 and transmits, to the access network device 230, a second message comprising an availability indicator.

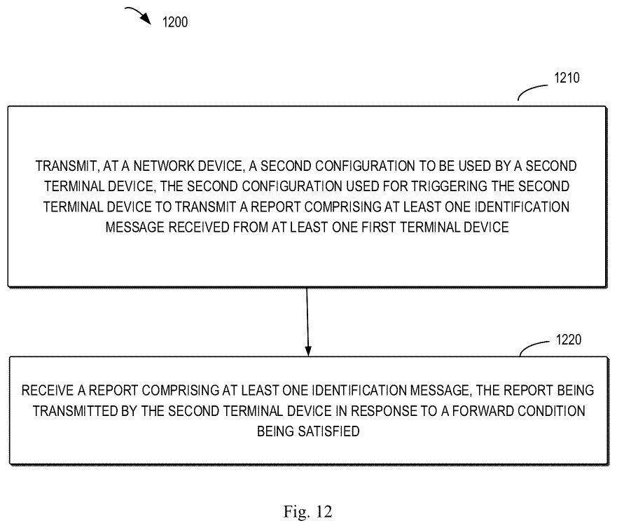

FIG. 12 illustrates a flowchart of an example method 1200 in accordance with some embodiments of the present disclosure. For example, the method 1200 can be implemented at the network device (either the access network device 230 or the core network device 240 as shown in FIG. 2).

At block 1210, the network device transmits a second configuration to be used by a second terminal device 220, where the second configuration is used for triggering the second terminal device 220 to transmit a report comprising at least one identification message received from at least one first terminal device 210.

At block 1220, the network device receives a report comprising at least one identification message, the report being transmitted by the second terminal device 220 in response to a forward condition being satisfied.

In some embodiments, the second configuration indicates at least one of the following: aircraft information of interests associated with a first terminal device 210, comprising at least one of latitude, longitude and barometric pressure altitude, aircraft information of interest associated with a control station, comprising at least one of latitude and longitude, barometric pressure altitude, spatial area of interests, a first valid time window for identifying a first terminal device 210, a transmission manner to be used by the second terminal device 220 for transmitting the report, value of a timer, associated with a transmission interval between two successive reports, or information about at least one event which triggers an event-based transmission of the report.

In some embodiments, the transmission manner is one of the following: a one-shot transmission, a periodical transmission, or an event-based transmission.

In some embodiments, the network device is an access network device 230, the second configuration is a measurement configuration transmitted to the access network device 230, and the report is a measurement report.

In some embodiments, the network device is an access network device 230, the second configuration is included in an RRC reconfiguration message transmitted to the access network device 230, and the report is transmitted as UE assistance information.

In some embodiments, the network device is an access network device 230, the second configuration is included in a UE information request transmitted to the access network device 230, and the report is a UE information response.

In some embodiments, prior to transmitting the second configuration, the network device receives a second message comprising an availability indicator.

In some embodiments, the network device is an access network device 230, the network device receives a third configuration from a core network device, and generates the second configuration based on the third configuration.

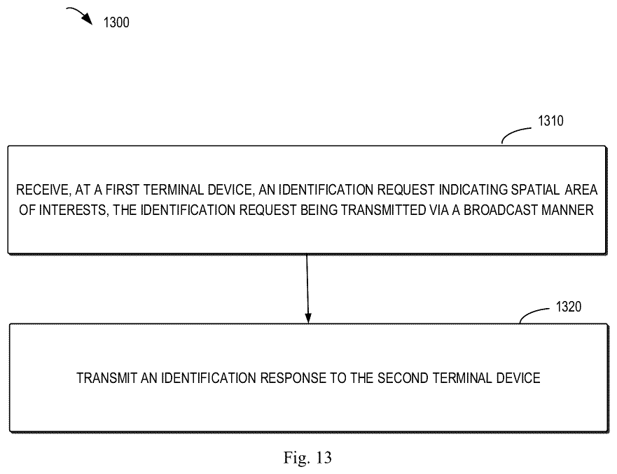

FIG. 13 illustrates a flowchart of an example method 1300 in accordance with some embodiments of the present disclosure. For example, the method 1300 can be implemented at the first terminal device 210 as shown in FIG. 2.

At block 1310, the first terminal device 210 receives an identification request indicating spatial area of interests, the identification request being transmitted via a broadcast manner.

At block 1320, the first terminal device 210 transmits an identification response to the second terminal device 220.

In some embodiments, the identification request further comprises at least one of the following: a presence identify indication, information about the second terminal device 220, or a second valid time window to be used by the first terminal device 210 for transmitting the identification response.

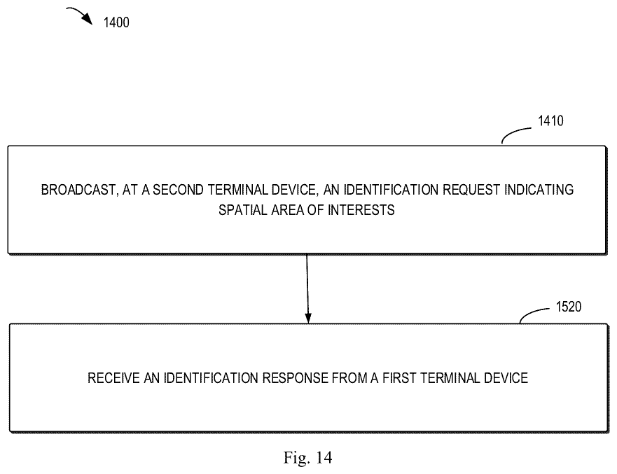

FIG. 14 illustrates a flowchart of an example method 1400 in accordance with some embodiments of the present disclosure. For example, the method 1400 can be implemented at the second terminal device 220 as shown in FIG. 2.

At block 1410, the second terminal device 220 broadcasts an identification request indicating spatial area of interests.

At block 1420, the second terminal device 220 receives an identification response from a first terminal device 210.

In some embodiments, the identification request further comprises at least one of the following: a presence identify indication, information about the second terminal device 220, or a second valid time window to be used by the first terminal device 210 for transmitting the identification response.

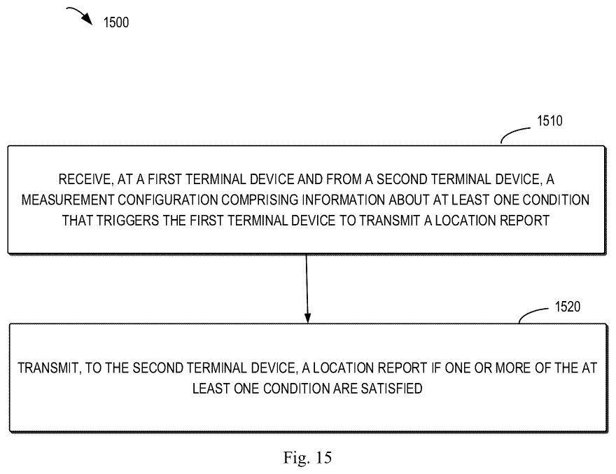

FIG. 15 illustrates a flowchart of an example method 1500 in accordance with some embodiments of the present disclosure. For example, the method 1500 can be implemented at the first terminal device 210 as shown in FIG. 2.

At block 1510, the first terminal device 210 receives, from a second terminal device 220, a measurement configuration comprising information about at least one condition that triggers the first terminal device 210 to transmit a location report.

At block 1510, the first terminal device 210 transmits, to the second terminal device 220, a location report if one or more of the at least one condition are satisfied.

In some embodiments, the information about at least one condition comprises at least one of the following: a reference location, a height threshold, or a distance threshold between the first terminal device 210 and the second terminal device 220.

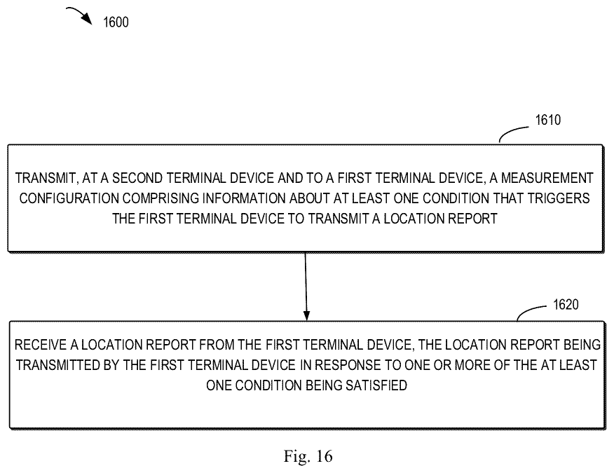

FIG. 16 illustrates a flowchart of an example method 14600 in accordance with some embodiments of the present disclosure. For example, the method 1600 can be implemented at the second terminal device 220 as shown in FIG. 2.

At block 1610, the second terminal device 220 transmits, to a first terminal device 210, a measurement configuration comprising information about at least one condition that triggers the first terminal device 210 to transmit a location report.

At block 1620, the second terminal device 220 receives a location report from the first terminal device 210, the location report being transmitted by the first terminal device 210 in response to one or more of the at least one condition being satisfied.

In some embodiments, the information about at least one condition comprises at least one of the following: a reference location, a height threshold, or a distance threshold between the first terminal device 210 and the second terminal device 220.

### Example Devices

In some example embodiments, the first terminal device 210 comprises circuitry configured to: determine that a broadcast condition for an identification message is satisfied in response to at least one of the following: a connection status between the first terminal device 210 and an access network device 230 failing to satisfy a connection requirement; a time interval since a last transmission of an identification message of the first terminal device 210 exceeding a period threshold, the first terminal device 210 entering into a specific spatial area, or receiving an indication from an upper layer of the first terminal device 210, the indication instructing the first terminal device 210 to broadcast the identification message of the first terminal device 210; and broadcast the identification message of the first terminal device 210.

In some example embodiments, the circuitry is further configured to: determines that the connection status fails to satisfy the connection requirement in response to at least one of the following: a signal quality between the first terminal device 210 and the access network device 230 being lower than a quality threshold; detecting a physical layer failure; detecting a radio link failure; leaving a connected state; entering into an idle state; entering any cell selection state; or being camped on an any cell.

In some example embodiments, the circuitry is further configured to: determine that the first terminal device 210 leaves the connected state in response to at least one of the following: a radio link failure, a beam failure, an initiation of RRC re-establishment procedure, an RRC re-establishment procedure failure, a cell selection, a cell reselection, a handover failure, a reception of handover command, or a random access procedure failure.

In some embodiments, the circuitry is further configured to: upon receiving the indication from the upper layer, transmit a first message to the access network device 230, the first message indicating: a stop of transmitting the identification message of the first terminal device 210 to the access network device 230, or a start of broadcasting the identification message indicating the identification of the first terminal device 210.

In some embodiments, the identification message comprises at least one of the following: a UAS identification of the first terminal device 210, aircraft information of the first terminal device 210, associated with at least one of latitude, longitude and barometric pressure altitude, aircraft information of a control station for the first terminal device 210, associated with at least one of latitude and longitude, barometric pressure altitude of the control station, a time mark identifying the UTC time of applicability of a position source output, an indication of the emergency status of the UAS, a service preference, UAV data of the first terminal device 210, UAV controller data of the first terminal device 210, paring information of the first terminal device 210 and a controller of the first terminal device 210, or a cause for broadcasting the identification message.

In some embodiments, the UAS identification is one of the following: a serial number of the first terminal device 210, a CAA-Level UAV ID of the first terminal device 210-1, a session identity, an international mobile equipment identity, a mobile station international subscriber directory number, an IP address, a MAC address.

In some embodiments, the broadcast condition is pre-defined or obtained from a first configuration indicating the broadcast condition from the access network device 230.

In some example embodiments, the circuitry is further configured to: transmit the identification message via a sidelink transmission or PC 5 interface.

In some example embodiments, the second terminal device 220 comprises circuitry configured to: receive a second configuration from a network device, the second configuration being used for triggering the second terminal device 220 to transmit a report comprising at least part of at least one identification message, the at least one identification message being received from at least one first terminal device 210; and transmit, to the network device, the report comprising at least part of the at least one identification message if a forward condition is satisfied.

In some embodiments, the second configuration indicates at least one of the following: aircraft information of interests associated with a terminal device, comprising at least one of latitude, longitude and barometric pressure altitude, aircraft information of interest associated with a control station, comprising at least one of latitude and longitude, barometric pressure altitude, spatial area of interests, a first valid time window for identifying a first terminal device 210, a transmission manner to be used by the second terminal device 220 for transmitting the report, value of a timer, associated with a transmission interval between two successive reports, or information about at least one event which triggers an event-based transmission of the report.

In some example embodiments, the circuitry is further configured to: filter, based on the second configuration, the at least one identification message received from the at least one first terminal device 210, and transmit the report comprising the filtered at least one identification message.

In some embodiments, the transmission manner is one of the following: a one-shot transmission, a periodical transmission, or an event-based transmission.

In some example embodiments, the circuitry is further configured to: determine that the forward condition is satisfied in response to at least one of the following: a number of received identification messages exceeding a number threshold; a number of the filtered at least one identification message exceeding a number threshold; the first terminal device 210 entering into a specific area; or a distance between the first terminal device 210 and the second terminal device 220 exceeding a distance threshold.

In some embodiments, the network device is an access network device 230, the second configuration is a measurement configuration received from the access network device 230, and the report is a measurement report.

In some embodiments, the network device is an access network device 230, the second configuration is included in an RRC reconfiguration message received from the access network device 230, and the report is transmitted as UE assistance information.

In some embodiments, the second terminal device 220 transmits the report if a timer started in response to transmitting a latest report is not running, and restarts the timer in response to transmitting the report.

In some embodiments, the network device is an access network device 230, the second configuration is included in a UE information request received from the access network device 230, and the report is a UE information response.

In some example embodiments, the network device is an access network device 230. Further, the circuitry is further configured to: prior to receiving the second configuration, receive the at least one identification message from at least one first terminal device 210, and transmit, to the access network device 230, a second message comprising an availability indicator.

In some example embodiments, the network device (either the access network device 230 or the core device 240) comprises circuitry configured to: transmit a second configuration to be used by a second terminal device 220, where the second configuration is used for triggering the second terminal device 220 to transmit a report comprising at least one identification message received from at least one first terminal device 210; and receive a report comprising at least one identification message, the report being transmitted by the second terminal device 220 in response to a forward condition being satisfied.

In some embodiments, the second configuration indicates at least one of the following: aircraft information of interests associated with a first terminal device 210, comprising at least one of latitude, longitude and barometric pressure altitude, aircraft information of interest associated with a control station, comprising at least one of latitude and longitude, barometric pressure altitude, spatial area of interests, a first valid time window for identifying a first terminal device 210, a transmission manner to be used by the second terminal device 220 for transmitting the report, value of a timer, associated with a transmission interval between two successive reports, or information about at least one event which triggers an event-based transmission of the report.

In some embodiments, the transmission manner is one of the following: a one-shot transmission, a periodical transmission, or an event-based transmission.

In some embodiments, the network device is an access network device 230, the second configuration is a measurement configuration transmitted to the access network device 230, and the report is a measurement report.

In some embodiments, the network device is an access network device 230, the second configuration is included in an RRC reconfiguration message transmitted to the access network device 230, and the report is transmitted as UE assistance information.

In some embodiments, the network device is an access network device 230, the second configuration is included in a UE information request transmitted to the access network device 230, and the report is a UE information response.

In some example embodiments, the circuitry is further configured to: prior to transmitting the second configuration, receive a second message comprising an availability indicator.

In some embodiments, the network device is an access network device 230, the network device receives a third configuration from a core network device, and generates the second configuration based on the third configuration.

In some example embodiments, the first terminal device 210 comprises circuitry configured to: receive an identification request indicating spatial area of interests, the identification request being transmitted via a broadcast manner; and transmit an identification response to the second terminal device 220.

In some embodiments, the identification request further comprises at least one of the following: a presence identify indication, information about the second terminal device 220, or a second valid time window to be used by the first terminal device 210 for transmitting the identification response.

In some example embodiments, the second terminal device 220 comprises circuitry configured to: broadcast an identification request indicating spatial area of interests; and receive an identification response from a first terminal device 210.

In some embodiments, the identification request further comprises at least one of the following: a presence identify indication, information about the second terminal device 220, or a second valid time window to be used by the first terminal device 210 for transmitting the identification response.

In some example embodiments, the first terminal device 210 comprises circuitry configured to: receive, from a second terminal device 220, a measurement configuration comprising information about at least one condition that triggers the first terminal device 210 to transmit a location report; and transmit, to the second terminal device 220, a location report if one or more of the at least one condition are satisfied.

In some embodiments, the information about at least one condition comprises at least one of the following: a reference location, a height threshold, or a distance threshold between the first terminal device 210 and the second terminal device 220.

In some example embodiments, the second terminal device 220 comprises circuitry configured to: transmit, to a first terminal device 210, a measurement configuration comprising information about at least one condition that triggers the first terminal device 210 to transmit a location report; and receive a location report from the first terminal device 210, the location report being transmitted by the first terminal device 210 in response to one or more of the at least one condition being satisfied.

In some embodiments, the information about at least one condition comprises at least one of the following: a reference location, a height threshold, or a distance threshold between the first terminal device 210 and the second terminal device 220.

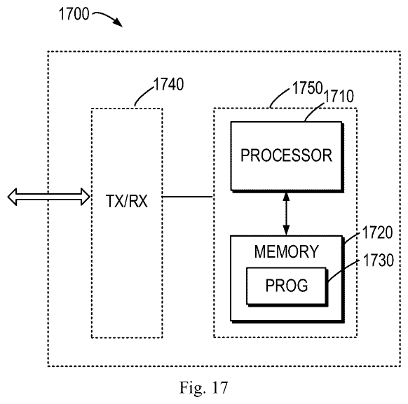

FIG. 17 is a simplified block diagram of a device 1700 that is suitable for implementing embodiments of the present disclosure. The device 1700 can be considered as a further example implementation of the first terminal device 210, the second terminal device 220, the access network device 230 and the core network device 240 as shown in FIG. 2. Accordingly, the device 1700 can be implemented at or as at least a part of the first terminal device 210, the second terminal device 220, the access network device 230 and the core network device 240.

As shown, the device 1700 includes a processor 1710, a memory 1720 coupled to the processor 1710, a suitable transmitter (TX) and receiver (RX) 1740 coupled to the processor 1710, and a communication interface coupled to the TX/RX 1740. The memory 1710 stores at least a part of a program 1730. The TX/RX 1740 is for bidirectional communications. The TX/RX 1740 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1730 is assumed to include program instructions that, when executed by the associated processor 1710, enable the device 1700 to operate in accordance with the embodiments of the present disclosure, as discussed herein with reference to FIGS. 2-16. The embodiments herein may be implemented by computer software executable by the processor 1710 of the device 1700, or by hardware, or by a combination of software and hardware. The processor 1710 may be configured to implement various embodiments of the present disclosure. Furthermore, a combination of the processor 1710 and memory 1720 may form processing means 1750 adapted to implement various embodiments of the present disclosure.

The memory 1720 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1720 is shown in the device 1700, there may be several physically distinct memory modules in the device 1700. The processor 1710 may be of any type suitable to the local technical network, and may include one or more of general purpose computers, special purpose computers, microprocessors, digital signal processors (DSPs) and processors based on multicore processor architecture, as non-limiting examples. The device 1700 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2-16. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method of communication, comprising:
determining, at a first terminal device, a broadcast condition for an identification message is satisfied in response to at least one of the following:
a connection status between the first terminal device and an access network device failing to satisfy a connection requirement;
a time interval since a last transmission of an identification message of the first terminal device exceeding a period threshold;
the first terminal device entering into a specific spatial area; or
receiving an indication from an upper layer of the first terminal device, the indication instructing the first terminal device to broadcast the identification message of the first terminal device; and
broadcasting the identification message of the first terminal device.

2. The method of claim 1, further comprising:
determining the connection status fails to satisfy the connection requirement in response to at least one of the following:
a signal quality between the first terminal device and the access network device being lower than a quality threshold;
detecting a physical layer failure;
detecting a radio link failure;
leaving a connected state;
entering into an idle state;
entering any cell selection state; or
being camped on an any cell.

3. The method of claim 2, further comprising:
determining the first terminal device leaves the connected state in response to at least one of the following:
a radio link failure,
a beam failure,
an initiation of radio resource control (RRC) re-establishment procedure,
an RRC re-establishment procedure failure,
a cell selection,
a cell reselection,
a handover failure,
a reception of handover command, or
a random access procedure failure.

4. The method of claim 1, further comprising:
upon receiving the indication from the upper layer, transmitting, to the access network device, a first message indicating:
a stop of transmitting the identification message of the first terminal device to the access network device, or
a start of broadcasting the identification message indicating the identification of the first terminal device.

5. The method of claim 1, wherein the identification message comprises at least one of the following:
an unmanned aircraft systems (UAS) identification of the first terminal device,
aircraft information of the first terminal device, associated with at least one of latitude, longitude and barometric pressure altitude,
aircraft information of a control station for the first terminal device, associated with at least one of latitude and longitude, barometric pressure altitude of the control station,
a time mark identifying the coordinated universal time (UTC) time of applicability of a position source output,
an indication of the emergency status of the UAS,
a service preference,
unmanned aerial vehicle (UAV) data of the first terminal device,
UAV controller data of the first terminal device,
paring information of the first terminal device and a controller of the first terminal device, or
a cause for broadcasting the identification message.

6. The method of claim 5, wherein the UAS identification is one of the following:
a containing clear channel assessment (CAA)-level UAV identification (ID) of the first terminal device,
a serial number of the first terminal device,
a session identity,
an international mobile equipment identity,
a mobile station international subscriber directory number,
an internet protocol (IP) address,
a media access control (MAC) address.

7. The method of claim 1, wherein the broadcast condition is pre-defined or obtained from a first configuration indicating the broadcast condition from the access network device.

8. The method of claim 1, wherein broadcasting the identification message comprises:
transmitting the identification message via a sidelink transmission or PC 5 interface.

9. A method of communication, comprising:
receiving, at a second terminal device, a second configuration from a network device, the second configuration being used for triggering the second terminal device to transmit a report comprising at least part of at least one identification message, the at least one identification message being received from at least one first terminal device; and
transmitting, to the network device, the report comprising at least part of the at least one identification message if a forward condition is satisfied.

10. The method of claim 9, wherein the second configuration indicates at least one of the following:
aircraft information of interests associated with a terminal device, comprising at least one of latitude, longitude and barometric pressure altitude,
aircraft information of interest associated with a control station, comprising at least one of latitude and longitude, barometric pressure altitude,
spatial area of interests,
a first valid time window for identifying a first terminal device,
a transmission manner to be used by the second terminal device for transmitting the report,
value of a timer, associated with a transmission interval between two successive reports, or
information about at least one event which triggers an event-based transmission of the report.

11. The method claim 10, wherein transmitting the report comprises:
filtering, based on the second configuration, the at least one identification message received from the at least one first terminal device; and
transmitting the report comprising the filtered at least one identification message.

12. The method of claim 10, wherein the transmission manner is one of the following:
a one-shot transmission,
a periodical transmission, or
an event-based transmission.

13. The method of claim 11, further comprising:
determining the forward condition is satisfied in response to at least one of the following:
a number of received identification messages exceeding a number threshold;
a number of the filtered at least one identification message exceeding a number threshold;
the first terminal device entering into a specific area; or
a distance between the first terminal device and the second terminal device exceeding a distance threshold.

14. The method of claim 9, wherein the network device is an access network device, the second configuration is a measurement configuration received from the access network device, and the report is a measurement report.

15. The method of claim 9, wherein the network device is an access network device, the second configuration is included in a radio resource control (RRC) reconfiguration message received from the access network device, and the report is transmitted as user equipment (UE) assistance information.

16. The method of claim 9, wherein transmitting the report comprises:
transmitting the report if a timer started in response to transmitting a latest report is not running; and
restarting the timer in response to transmitting the report.

17. The method of claim 9, wherein the network device is an access network device, the second configuration is included in a user equipment (UE) information request received from the access network device, and the report is a UE information response.

18. The method of claim 9, wherein the network device is an access network device, and
wherein prior to receiving the second configuration the method further comprises:
receiving the at least one identification message from at least one first terminal device; and
transmitting, to the access network device, a second message comprising an availability indicator.

19. A method of communication, comprising:
transmitting, at a network device, a second configuration to be used by a second terminal device, the second configuration used for triggering the second terminal device to transmit a report comprising at least one identification message received from at least one first terminal device; and
receiving a report comprising at least one identification message, the report being transmitted by the second terminal device in response to a forward condition being satisfied.

20.-42. (canceled)

43. The method of claim 19, wherein the network device is an access network device, and the method further comprises:
receiving a third configuration from a core network device;
generating the second configuration based on the third configuration.
